(19) United States
(12) Patent Application Publication
(10) Pub. No.: US 2012/0113011 A1
(43) Pub. Date: May 10, 2012

(54) IME TEXT ENTRY ASSISTANCE

(76) Inventors: Genqing Wu, Beijing (CN); Xiaotao Duan, Beijing (CN); Tai-Yi Huang, Bellevue, WA (US)

(21) Appl. No.: 13/257,074

(22) PCT Filed: Mar. 20, 2009
(86) PCT No.: PCT/CN2009/070927

§ 371 Date: Jan. 20, 2012

(51) Int. Cl. G06F 3/041

(52) U.S. Cl. 345/169

(57) ABSTRACT

A computer-implemented user interface method is disclosed that includes displaying on a touch screen of a computing device a keyboard defined by a first character set; displaying on the touch screen an electronic canvas on which information corresponding to keys on the keyboard is displayed as a user selects the keys on the keyboard, the information appearing in a second character set that differs from the first character set; generating a candidate area over a front surface of the canvas; and automatically controlling a location of the candidate area as information is added to the canvas so as to move the candidate area away from being over a location on the canvas that is presently, or next to be, a location at which information is added to the canvas.

### TECHNICAL FIELD

This document relates to systems and techniques for interacting with a user who enters characters into an input method editor (IME) system, such as by entering Roman characters that are converted to Japanese or Chinese characters.

### BACKGROUND

Computing devices keep getting more powerful at the same time that they shrink in size. Portable devices such as smart phones can now perform many of the computing functions that previously were performed only by desktop computers. Both the processing power and the graphical capabilities of such devices have improved enormously. Also, modern data networks permit such mobile devices to perform functions that require nearly consistent, and high-bandwidth, connections to the internet.

Many of the functions performed on mobile devices center around communications. For example, users may send and receive text messages or e-mails. A user may also typically send queries to search engines so as to retrieve search results, including local search results, such as the identification of a certain style of restaurants in the area around a user. Textual entry on mobile devices can be difficult because the small size of the devices prevents the devices from offering fully functional, and full-sized keyboards. Such problems are magnified when communicating via a language whose symbols are not fully supported by a typical keyboard having a Roman (e.g. English) character set. For example, Chinese language entry may be performed using an Input Method Editor (IME) that receives Roman characters, using an alternative representation such as Pinyin. Entry of such information can be difficult, for example, when a particular Roman representation entered by a user is ambiguous, in that it has multiple interpretations in the target character set. As a result, an IME may provide a candidate box along with a Roman keyboard (which can be a virtual keyboard on a touch screen device), and the candidate box may present to a user possible solutions for an entry that the user has made. The user may then select the appropriate entry out of the candidate box.

### SUMMARY

This document describes systems and techniques that may be employed to interact with a user of a computing device like a mobile telephone that has a touch screen user interface. In general, the techniques may by performed as part of an IME application that reacts to user input of characters in one character set to produce characters in another character set. In one example, a candidate box for an IME application is allowed to “float” over a text entry application so that it can be undocked from a soft or virtual keyboard and can thus leave more room for a canvas of the text entry application. (A canvas is an area in which data entered by a user of the device appears as the user enters and accepts the data, such as the “paper” for a word processing application, a note for a notepad application, or a body of an e-mail that is being drafted.)

Other space-saving solutions are also provided. For example, added keys and functionality may be provided on a keyboard that is too large to fit on a screen of a device at one time. A user may perform a lateral swiping motion on the keyboard to move from one part of the keyboard to another. Similarly, a candidate box or window may provide more candidates than can fit on a single screen of the device. A user may perform a lateral swiping motion with his or her finger or another pointer, so as to slide the additional candidates into view.

Certain of the keys on a keyboard, particularly in an extended portion of a keyboard, can be context dependent. For example, certain keys can show an emoticon, and the emoticon may be an image that has been assigned to the key by a user, or can be an emoticon that has been determined by a system to be a particularly popular emoticon. For example, a system may analyze text entry by a plurality of different users, independent of the user of the device, to determine what emoticons they often use. One example of such analysis may be conducted on submitted search queries, or on test messages or e-mail messages (with appropriate privacy restrictions).

In addition, such monitoring of popular usage may be used to generate words, phrases, or even longer sentences that can be suggested to a user of a device. For example, if users of a search system suddenly start entering a particular phrase in search queries, such as because the subject of the phrase has recently become popular in the news, the phrase may be elevated as a phrase that is more frequently or more prominantly suggested to other users by the system in an IME application. Certain of such candidates may use a “trends” application, where candidates are elevated in prominence during particular times of the year that appear, from prior trends data, to be cyclical. For example, certain phrases or terms for sports become more common when tournaments for those sports are occurring. Similar observations may be made with respect to seasonal weather-related events, and holidays, which are cyclical. In such a manner, the system may begin offering candidates even before they have become popular with other users during a cycle.

In certain implementations, such systems and technique may provide one or more advantages. For example, a user of a computing device can more easily and accurately enter information in a language whose character set is not directly supported by a keyboard on the computing device. Also, a user may receive candidates that can improve their entry of text on a device, so that they can more effectively and efficiently communicate with other users or with various hosted services using their device.

In one implementation, a computer-implemented user interface method is disclosed. The method comprises displaying on a touch screen of a computing device a keyboard defined by a first character set, and displaying on the touch screen an electronic canvas on which information corresponding to keys on the keyboard is displayed as a user selects the keys on the keyboard, the information appearing in a second character set that differs from the first character set. The method also comprises generating a candidate area over a front surface of the canvas, and automatically controlling a location of the candidate area as information is added to the canvas so as to move the candidate area away from being over a location on the canvas that is presently, or next to be, a location at which information is added to the canvas. The method can also include receiving a user input to dock the candidate area to the keyboard, and subsequently maintaining the candidate area docked to the keyboard until a subsequent user input to undock the candidate area from the keyboard.

In some aspects, the first character set comprises a Roman-based character set and the second character set comprises a symbolic character set. The method can also comprise receiving a user selection of a candidate in the candidate area, adding the selected candidate to the canvas, and moving the candidate window if the candidate window substantially obscures a next data entry area on the canvas. In addition, the method can include changing an aspect ratio of the candidate area and moving the candidate area laterally near a side of the display. In addition, the method can include receiving a lateral swiping input on the keyboard, and panning the keyboard in a direction of the lateral swiping input. Moreover, the method can include receiving a lateral swiping motion in the candidate area, and panning a plurality of candidate entries in the candidate area in response to the lateral swiping motion.

In another implementation, an article comprising a computer-readable data storage medium storing program code operable to cause one or more machines to perform operations is disclosed. The operations comprise displaying on a touch screen of a computing device a keyboard defined by a first character set, displaying on the touch screen an electronic canvas on which information corresponding to keys on the keyboard is displayed as a user selects the keys on the keyboard, the information appearing in a second character set that differs from the first character set, generating a candidate area over a front surface of the canvas, and automatically controlling a location of the candidate area as information is added to the canvas so as to move the candidate area away from being over a location on the canvas that is presently or about to be a location at which information is added to the canvas. The program code can also be operable to perform operations including receiving a user input to dock the candidate area to the keyboard, and subsequently maintaining the candidate area docked to the keyboard until a subsequent user input to undock the candidate area from the keyboard.

In some aspects, the first character set comprises a Roman-based character set and the second character set comprises a symbolic character set. Also, the program code can be operable to perform operations including receiving a user selection of a candidate in the candidate area, adding the selected candidate to the canvas, and moving the candidate window if the candidate window substantially obscures a next data entry area on the canvas. The program code can additionally be operable to perform operations including changing an aspect ratio of the candidate area and moving the candidate area laterally near a side of the display.

In yet another implementation, a computer-implemented user interface system is disclosed, and includes a graphical display system to present an input method editor and a text entry application having a canvas area for displaying user-entered information and a candidate area for presenting symbols to be added to the canvas area. The system also includes a touch screen user input mechanism to receive user selections in coordination with the display of the image method editor, and an input method interface manager module that is operable with the image method editor to automatically control a location of the candidate area as information is added to the canvas so as to move the candidate area away from being over a location on the canvas that is presently, or next to be, a location at which information is added to the canvas. The image method editor can be operable to receive input in a first character set and generate output in a second character set that is different than the first character set that does not correspond to keys on the touch screen user input mechanism. Also, the image method editor interface manager module can be further operable to receive a user selection of a candidate in the candidate area, provide the selected candidate for addition to the canvas, and cause the candidate window to be moved if the candidate window substantially obscures a next data entry area on the canvas.

In certain aspects, the image method editor interface manager module is further operable to automatically change an aspect ratio of the candidate area and move the candidate area laterally near a side of the display. Also, the touch screen user input mechanism can be operable to receive a lateral swiping input on a keyboard displayed on the graphical display, and the graphical display system is operable to pan the keyboard in a direction of the lateral swiping input, in response to the lateral swiping input. The touch screen user input mechanism can be operable to receive a lateral swiping input on the candidate area, and the graphical display system is operable to pan a plurality of candidate entries in the candidate area in response to the lateral swiping motion.

In another implementation, a computer-implemented user interface system is disclosed. The system includes a graphical display to present an input method editor and a text entry application having a canvas area for displaying user-entered information, a touch screen user input mechanism to receive user selections in coordination with the display of the image method editor, and means for generating a floating candidate window over a portion of the canvas.

The details of one or more embodiments are set forth in the accompanying drawings and the description below. Other features and advantages will be apparent from the description and drawings, and from the claims.

### DESCRIPTION OF DRAWINGS

FIG. 1 shows a series of screenshots of a mobile touch screen device having a floating candidate window.

FIG. 2A shows a series of screenshots of a mobile touch screen device having an enlarged, scrollable keyboard.

FIG. 2B shows a series of screenshots of under-customizable keyboards.

FIG. 3 shows a series of screenshots of a mobile touch screen device having a scrollable candidates box.

FIG. 4 is a schematic diagram of a system that provides user interaction in response to touch screen inputs for an IME system.

FIG. 5A is a flow chart of an example process for providing an automatically moving candidate box.

FIG. 5B is a flow chart of an example process for reacting to user input to an IME system.

FIG. 5C is a flow chart of an example process for providing hot terms as candidates on a mobile device.

FIG. 5D is a flow chart of an example process for providing hot emoticons or other symbols on a soft keyboard.

FIG. 6A is a swim lane diagram of an example process for providing current candidates for a user of a mobile device.

FIG. 6B is a swim lane diagram of an example process for providing popular emoticons to a computing device.

FIG. 7 shows an example of a computer device and a mobile computer device that can be used to implement the techniques described here.

Like reference symbols in the various drawings indicate like elements.

### DETAILED DESCRIPTION

This document describes systems and techniques by which mobile devices may interact with a user of such devices. For example, users may be able to enter characters in a first character set and to have output presented on a canvas in a second character set. A candidate box presenting possible solutions in the second character set for data entered in the first character set may be shown with the canvas, and may change its position relative to the canvas so that it moves out of the way of text that is being added to, or is about to be added to, the canvas. The candidate box may take a variety of forms, and its automatic movement may permit more of the canvas to be visible than would be possible with a permanently docked candidate box.

Also, certain text entry mechanisms may not fit on a single screen of a keyboard, or certain suggested candidates may not fit on a single screen of a candidate box. In such situations, a user may be permitted to swipe their finger laterally across the keyboard or the candidate box, respectively, in order to pan the keyboard or candidate box to the left or the right, in the direction of their swiping. Keys on such a supplemental or auxiliary keyboard may also be manually or automatically programmable, so as to represent characters in the second character set, words, phrase, sentences, or emoticons. For automatic programming of the keys, the keys may be assigned what have been determined to be popular words, phrases or sentences. The popularity may be determined by a central service that receives information from a variety of users, such as in the form of search requests or electronic communications (e.g., text messages or e-mails). Such popular words, phrases, or sentences may then be provided to keys on the keyboard automatically, so that a user of a device can quickly enter them into the device simply by pressing the relevant keys.

Popular terms can also be elevated in prominence in terms of being recommended to a user in a candidate box. Such elevation may occur by providing dictionary data to a user's device, where the device depends on dictionaries that indicate relative prominence of words in order to help the device rank suggestions that are shown in the candidate box. The system may maintain multiple dictionaries in the form of “atom” dictionaries, where each dictionary may be directed to a specific purpose. For example, a sports dictionary may contain representations in the second character set for the names of certain athletes, and the dictionary may be provided to a user who frequents certain sports-related websites, a user that completes a profile indicating that they are a sports fan, or a user who specifically asks for the sports-related atom dictionary.

The atom dictionaries or other dictionaries can also be tied to particular locations, in addition to, or instead or, particular topics. Such information may be provided, for example, to help users complete entry of search terms so that local-based terms are suggested, and also to help ensure that the user enters the terms without errors. Particular local information may be provided to a user's device depending on location indicators received form the device, such as an IP address, cell tower triangulation, or GPS coordinates. The local information can include, for example, local sightseeing spots, local restaurants, local cities, and other information. For example, users in Beijing, whether traveling or not, can be provided with an atom dictionary that contains the important names of the important POI (Points of Interests) like streets, restaurant, etc., or even some dialect words. Similarly, people in Shanghai can be provided with a Shanghai version.

Such dictionaries can particularly help users interact with mapping applications, such as when entering the Beijing specific street name “ [symbol] ,” that would not normally be in a main system dictionary. Ordinarily, a user would have to input three syllables “wu”, “dao” and “kou”, and chooses the correct characters one by one, but if he or she were provided with a local atom dictionary, he or she could simply input “wdk” (The first roman letter for each syllable) to get the candidates. As an example of a location-based atom dictionary helping a user enter proper characters, consider a traveler in Beijing who inputs “ [symbol] ” in Maps, and would not normally get any results because the correct word is “ [symbol] ” (The two strings pronounce in the same way). With a local atom dictionary, he or she would be more likely to input the right one. In this manner, a user's device can be loaded with multiple dictionaries that together provide suggestions in a candidate window of an IME. One of the dictionaries is a basic dictionary, while others may be situation-specific or user-specific dictionaries that are targeted to the current situation (e.g., location) of the user or known interests of the user.

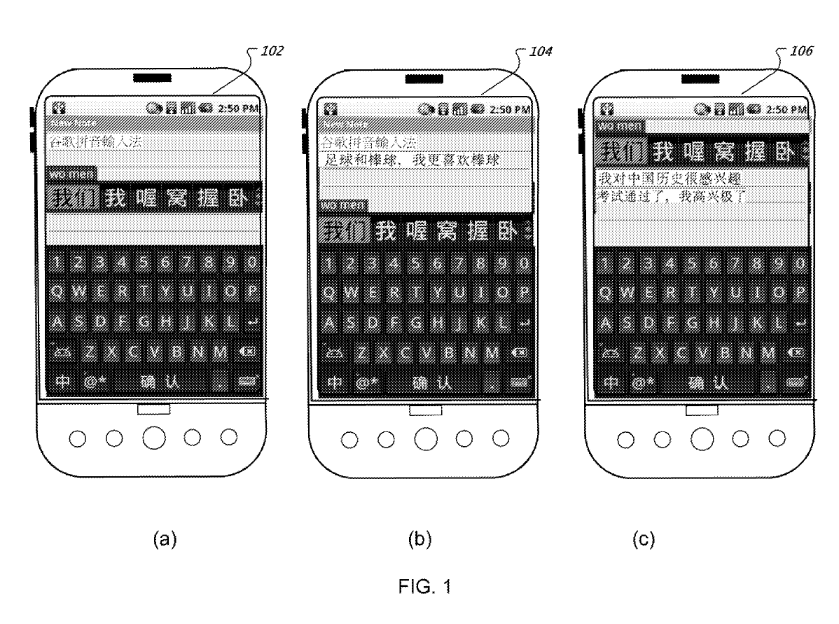

FIG. 1 shows a series of screenshots of a mobile touch screen device having a floating candidate window. In general, the device is shown in three examples 102-106 that show different states of the device, where a user is entering text for processing by an IME application on the device.

In the first example 102, marked by letter (a), the device is shown as displaying a lined canvas area where a user is entering Chinese characters using the IME. The application presenting the canvas is a “notes” application, and is relying on the IME to provide it with Chinese characters in response to a user's entry of Pinyin using Roman (also known as Latin) characters. The IME application presents the user with a Roman keyboard and a candidate window (which can also be called a candidate box, though it need not be rectangular in shape). The user has already entered one line of text to the notes application, and is in the process of entering another—“wo men.” This entry is shown in the candidate window, as are a number of candidate Chinese characters for the entry, that might match the entry. A user would select a key to have the highlighted candidate added to the canvas, or could touch on one of the other candidates, or touch and drag a candidate upward, to do the same with it.

The candidate window in this example is not docked to the keyboard, but is instead a floating window, which can appear in different areas over the canvas. In this manner, the device can allocate more screen area for the canvas, and a user can obtain a broader context of the text that he or she is entering into the device. For example, the user can be enabled to see one or two extra lines of the canvas, and to manipulate those extra lines more freely than If they were showing less of their text.

In example 102, labeled by the letter (b), the user has, instead of entering what they were prepared to enter in example 102 (Chinese characters for “wo men”), entered a phrase about sports. The device is now prepared to receive entry on the third line of the canvas. However, the candidate box previously (in example 102) covered the third line of the canvas. As a result, in example 104, the candidate box has moved downward and has automatically docked with the keyboard so as to create room on the canvas for the third line. If more room had been available on the canvas, the box could have simply moved down without docking, and if less room is available, the candidate box can overlap somewhat with the keyboard (including by covering the numerical keys in the top line of the keyboard). Also, when a keyboard is partially covered or reduced in size, certain functions of the keyboard can be performed by motions or sounds, such as by making a jerking upward motion of a device represent a Caps Lock, a downward shake a Enter key, and a rightward shake to represent a period punctuation followed by one or two spaces.

In example 106, represented by the letter (c), the user has entered yet a different phrase, and is now attempting to enter his or her original term “wo men” on the next line of the canvas. In this instance, the entry has gotten so low that there is no room for the candidate box. In such a situation, the canvas could be scrolled upward so as to uncover a new line on the canvas on which data entry could continue. However, as shown in example 106, the candidate window has instead automatically undocked from the soft keyboard and has moved up on top of some of the other lines on the display. The user may also move the candidate box to a more convenient location by pressing and sliding on it. Thus, if the primary candidate shown by the box is typically accurate, the user can slide the box to the right side of the device's display so that lower-ranked candidates are not even shown on the display, and the candidate box can take a narrower aspect ratio than is shown here. Also, the user could choose to slide the candidate box back down to its position from example 104, which will cause the window to become docked to the keyboard and to stay docked until the user again undocks the candidate box (i.e., no automatic undocking will occur in a session once a user has manually docked the box, until the user has manually undocked the box).

The aspect ratio of the candidate box or window may also be changed in other manners, just as the positioning of the box is changed. For example, if the box is over a lower line of a canvas and a user seeks to add text, the box may change from a generally horizontal orientation like that shown in FIG. 1, to a generally vertical orientation, where the multiple candidates are stacked on top of each other. Also, the box may be impervious to selections that are made in the canvas, and that overlap with the box. For example, if text is selected for a cut-and-paste operation, where a selection box overlaps with the candidate box, the text below the box may be selected, and the box may essentially be ignored.

In this manner, a candidate box or window may, in essence, float over a canvas in an IME system. The box may move automatically as text is added to the canvas, so that a greater amount of the canvas can be displayed to a user than would be possible if the box were docked around one or more edges of the canvas. Such an approach may permit a user to see more of the canvas, or at least more important parts of the canvas than they otherwise would.

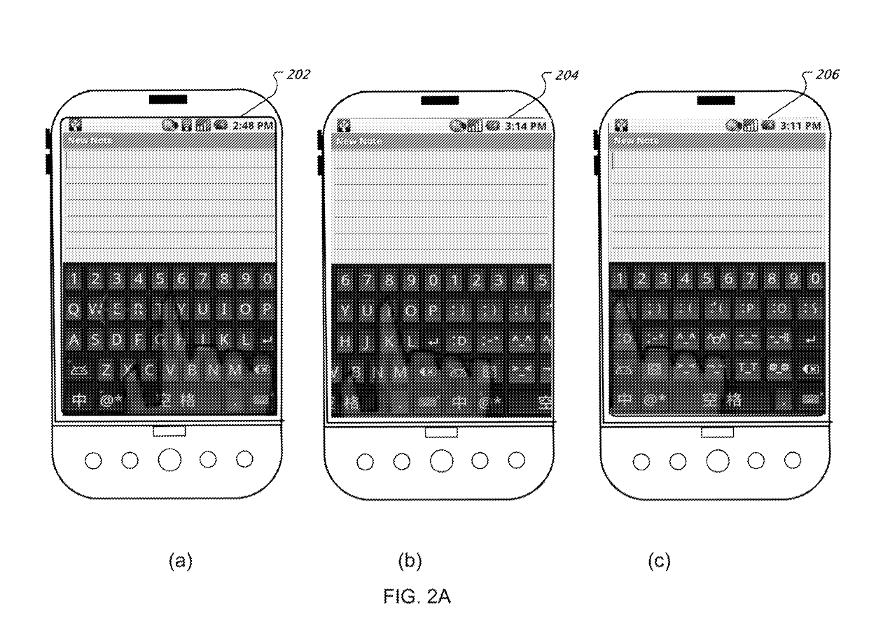

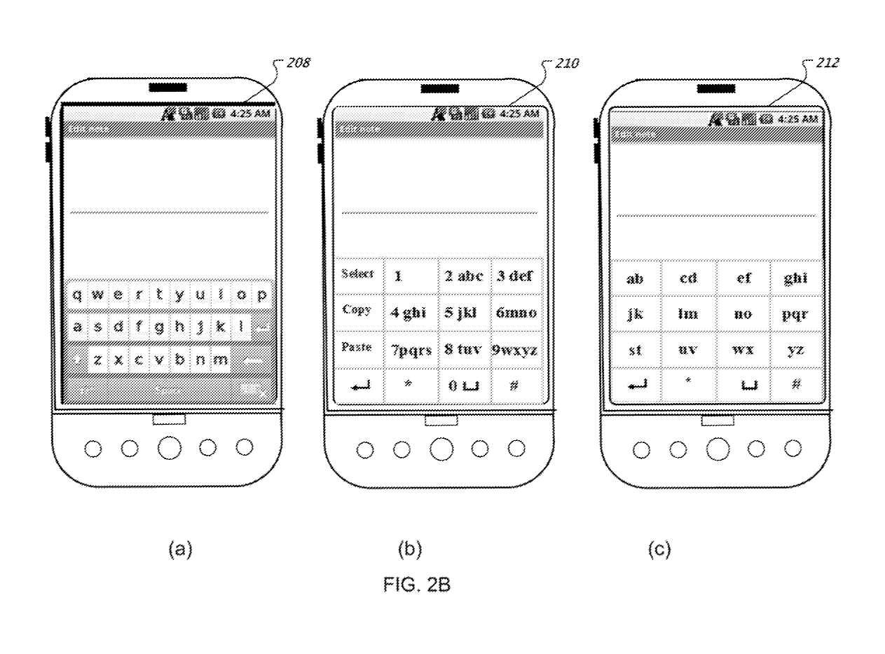

FIG. 2A shows a series of screenshots of a mobile touch screen device having an enlarged, scrollable keyboard. In general, the figures show a number of examples 202-206 of a keyboard for an IME application, where the keyboard is too large to fit on a single display.

In the first example 202, which is designated with the letter (a), a standard QWERTY keyboard is shown, though there is little room for keys other than the letters of the Roman alphabet and Arabic numbers. Also in example 102, a user's hand is shown, with the user's index finger pressing on an area of the keyboard (in this case, between the “T” and “Y” keys) and swiping to the left. This motion is interpreted by a processor in the device as a user command to slide the keyboard to the left.

At shown in example 204, which is designated (b), the keyboard has slid in response to the user's swiping leftward input. Now, a portion of the keyboard that was previously off to the right of the display is shown. This portion of the keyboard includes additional keys that were previously off to the right of the display conceptually. The keys can represent other characters in a character set or, in this example, they represent emoticons that a user can easily enter by pressing the appropriate key. As can be seen, the middle portion of the original display is still shown, and the numerals have repeated at the top but in a different order (though the top row could simply be slid over when the keyboard moves, and can thus remain in its original orientation and layout.

The sliding accomplished by the user may also be proportional to the distance that the user slid his or her finger (e.g., moving only a key or two if the user slides very little), but may be caused to jump or lock into the right-most position once the user has slid far enough. Where the full keyboard is twice the width of the display, the original keyboard can be wholly moved off the display (though some portions such as the row of numerals can move over) when a user swipes on the original keyboard. Alternatively, one-half of a display width of keyboard may be located on each side of the original keyboard, so that a user can move in either direction from the main keyboard (as shown in example 204). The “extra” portions of the keyboard can accomplish different functions or could even contain the same characters, so that a user's decision to swipe in one direction instead of the other simply controls the relative positioning of the keys on the supplemental portion of the keyboard, and which half of the original keyboard is to be shown.

The keys may also be made wider or narrower (or shorter or taller) by similar swiping motions. For example, to make keys narrower, and thus to fit more keys on a single display, a user may press a first finger on the display, then press a second finger and slide the second finger toward the first finger. Such motion may result in keys that were previously off the edge of the display closest to the second finger being brought onto the display. Sliding fingers away from each other can widen the keys. The narrowing or widening may occur as a live animation as the user is performing the sliding so that the user can immediately see the effect of his or her actions. Thus, a user with thin or pointy fingers may choose to see a more expansive keyboard but with smaller keys, with the understanding that they can still receive accurate input with such a keyboard. A user may also change the relative width of a keyboard in a similar manner if they change from text entry using their thumbs to entry using their fingertips.

The special symbols on the keys that are in addition to the normal keyboard, may be placed manually or automatically. For example, a user may select text from the canvas and may then long press on one of the keys on the keyboard to have the selected text assigned to the particular key. Certain keys, such as the keys in the central portion of the keyboard, may not be able to be assigned in this manner. With those keys and with other keys, however, the user may select certain text and then long press a key while holding down a control or function key at the same time. The text may then be assigned to any later pressing of the control or function key in combination with the lettered key. Such manual assignment of letters to keys may provide for an easy and intuitive way in which a user can create short cut keys.

Automatic assignment (as opposed to manual assignment) of characters or terms to a key may occur via a server-based process for assigning popular words or phrases to a key. Such popularity may be judged based on the usage of a term by other users, and it may be assumed that the user of a particular device will be more likely to use the term because those other users used it relatively frequently, so that the user of the device will appreciate a “hot key” being assigned to it. For example, a search engine system may determine terms or characters that are used often by its users and may identify those terms and characters so that they may be downloaded to mobile devices and assigned to keys on an extended keyboard. Where the term is too large to fit on a key (e.g., because it is a long phrase or sentence), a portion of the term or a placeholder may be displayed, and the full term may pop up from the key when a user puts their finger over the key. Also, a single key may act as the “popular phrases” key that a user can access whenever they want to find popular phrases, and their selection of the key may cause a pop up window of multiple popular phrases to be shown, so that the user can select one of the phrases by sliding their finger from the key up to the particular phrase in the pop up window, and releasing their finger from the touch screen display to have the term under the release point selected.

Example 206 shows a display that may result from a user swiping their finger a second time to the left or swiping their finger a longer distance and/or at a higher speed in the first swiping on example 202, As shown here, all of the original keyboard has been replaced with keys showing emoticons.

FIG. 2B shows a series of screenshots of user-customizable keyboards. In general, in each instance, the user has been enabled to select a keyboard that works best for their purposes and then to further customize the keyboard. In the first example 208, indicated by letter (a), the user displays a basic QWERTY keyboard on a mobile device. In the second example 210, indicated by letter (b), the user has switched to a “compressed” keyboard, where the keys are each larger, but each key has multiple letters assign to it. Also, the letters on the keys in this example are sorted alphabetically rather than according to the QWERTY standard. In the third example 212, indicated by letter (c), the letters are assigned in yet a different manner. As with the second example 210, multiple characters are assigned to each key, but the character-bearing keys are now greater in number so that only two characters are assigned to each key. As a result, less functionality can be displayed at one time by the keyboard, but the ambiguity created by each key press will be less, and programs for discerning the intended meaning of a user may operate better.

Such keyboards can be used with normal English language entry and also as part of an IME application. When a user touches a series of keys such as “k1 k2 k3” (where k1, k2, and k3 each indicate a soft key respectively), the IME will search in its dictionary (whether singular or as part of a combined group of atomic dictionaries) for all items (or item combinations—for example, a Chinese IME can give sentence-level candidates if user types a long series of keys) whose letters are matched to k1, k2 and k3 respectively, and may sort these candidates according to their scores. The scores may be generated using a dictionary that represents each word and has an indication of the relative frequency with which the word or phrase is used. In this way, the best matched candidate will be automatically suggested to a user. For example, if a user types “43556” in the second example 210, “hello” will be automatically suggested.

As noted, the dictionary may be automatically and continuously customized to a user or the user's situation. For example, if the user indicates an interest in a particular field or subject matter, words or phrases in that field or subject matter may be downloaded automatically to the user's device as part of an atomic dictionary. Likewise, if a user is observed to be in or near a particular location, such as a particular city, an atomic dictionary (e.g., containing peculiar street names or restaurant names) may be added to the user's device from a remote server on a network.

An application may also be provided to permit a user to freely alter the layout of his or her keyboard. For example, the user may start such an application by selecting one of several “base” keyboards that may be suggested to the user. The user may then press on alphanumeric characters on each key and slide the characters to other keys, such as to adjacent keys, so as to place greater or fewer characters on a particular key. The mapping of characters to keys may be stored in memory on the device in a simple table so that, when a user presses a particular key, the character or characters assigned to the key are passed to an application that is tracking the user's actions. Even “standard” keyboards that a user has not yet customized can use such a mapping interface that may provide an API to various applications working on a device, and when a user chooses to move characters between keys, the mapping in the table may simply change to match the user-provided changes to the keyboard layout.

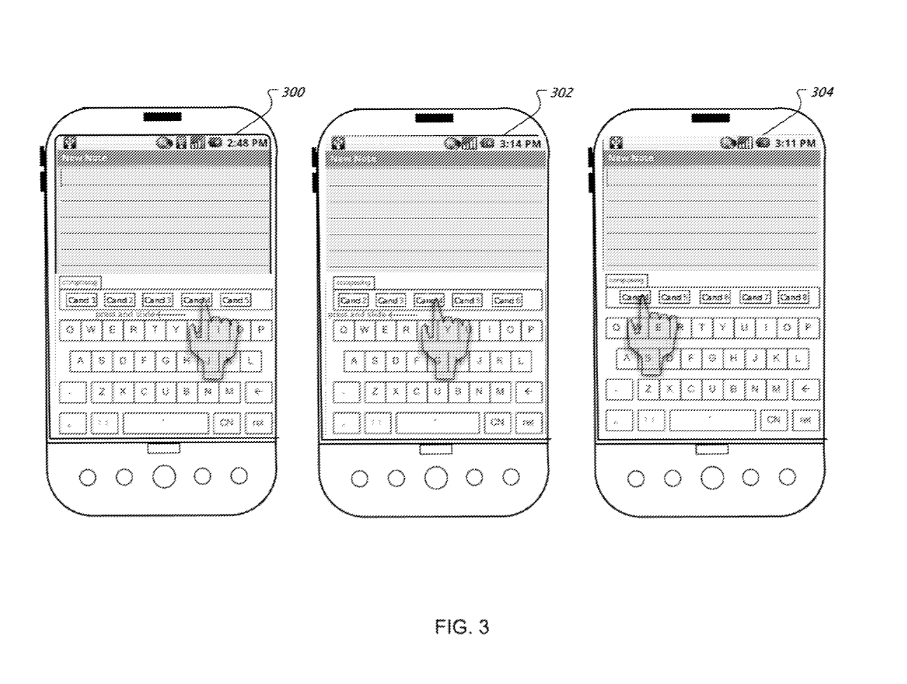

FIG. 3 shows a series of screenshots of a mobile touch screen device having a scrollable candidate box. In general, the candidate box may include too many candidates than can fit on a single display. While the top-scoring candidate may be shown first (i.e., in the leftmost position), such a candidate may not be the desired candidate, nor may any other candidates that are initially displayed, such as in example 300, represented by letter (a). Thus, as shown in example 300 and example 302, a user can press and swipe their finger along the candidates to pan or scroll the candidate window in a particular direction (whether to the left or right).

Thus, in example 302, the first candidate has been pushed off the left-hand edge of the screen and a sixth candidate has appeared at the right edge of the screen, with all the other candidates moving one notch to the left. In a like manner, the candidates have all moved another indexed position to the left in example 304. Such panning of the candidates can be set, in that only one candidate slot moves over for each user input. Alternatively, the panning may be proportionate, in that the degree of panning can be greater for faster or longer finger swipes. Also, the panning may be discrete or continuous. For example, the display may jump to each position or may “snap” into a position after a user has entered a panning input, so that the various candidates appear in repeatable positions laterally along the display. Alternatively, the display may be continuous or analog in that the candidate positions depend entirely on the degree of user input, and do not stop at or snap to particular positions.

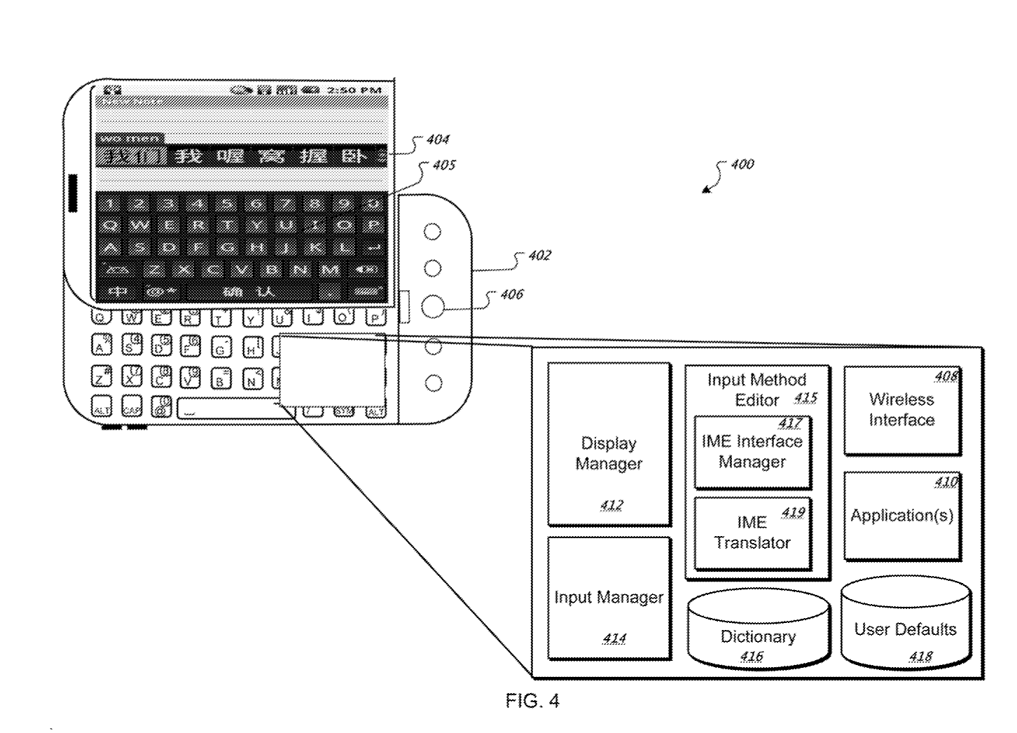

FIG. 4 is a schematic diagram of a system 400 that provides user interaction in response to touch screen inputs for an IME system. The system 400 may be implemented using a mobile device such as device 402. The device 402 includes various input and output mechanisms such as a touch screen display 404 and a roller ball 406. A number of components within device 402 may be configured to provide various selection functionality on display 404, such as selection and entry of information in an IME application.

One such component is a display manager 412, which may be responsible for rendering content for presentation on display 404. The display manager 412 may receive graphic-related content from a number of sources and may determine how the content is to be provided to a user. For example, a number of different windows for various applications 410 on the device 404 may need to be displayed, and the display manager 412 may determine which to display, which to hide, and what to display or hide when there is overlap between various graphical objects.

The display manager 412 can include various components to provide particular functionality for interacting with displayed components, which may be shared across multiple applications, and may be supplied, for example, by an operating system of device 402. Such functionality may be provided, for example, by input method editor application (IME) 415, which may be responsible for receiving input from a user and converting the information to a form that has a different character set. In this example, a Roman keyboard 405 is shown on display 404, and may be similar to keyboards shown in the screenshots above. In particular, the keyboard 405 may be provided in combination with features from other applications, where the keyboard 405 serves as an input mechanism for the other applications, and a converter from one character set to another.

The keyboard 405 and other IME functionality may be provided by the IME 415 running on the device. The IME 415 may be a part of the device operating system or may be an independent application, and may provide an API to other applications so that they can receive input from it. Also, in this example, the device has a regular “hard” keyboard, and input control may pass from the hard keyboard to the soft keyboard when the screen of the device is slid far enough out of the way of the hard keyboard so that it can be used reliably.

The operating system and display manager 412 may cooperate so as to show the IME features overlaid on the other applications. Such presentation of the IME 415 may be handled by the IME interface manager 417, which may be responsible for the manner in which the IME 415 is presented to a user. For example, the IME interface manager 417 may graphically present the keyboard and candidate box in manners like those discussed above and below. An IME translator 419 is responsible for generating the content for the IME 415. For example, the IME translator 419 is responsible for receiving Roman characters entered by a user and converting those characters into one or more candidates. Individual applications 410 can register themselves with the display manager 412 in accordance with an API so as to indicate the sort of display elements they might require.

An input manager 414 may be responsible for translating commands provided by a user of device 402. For example, such commands may come from a keyboard, from touch screen display 404, from trackball 406, or from other such sources, including dedicated buttons or soft buttons (e.g., buttons whose functions may change over time, and whose functions may be displayed on areas of display 404 that are adjacent to the particular buttons). The input manager 414 may determine, for example, in what area of the display commands are being received, and thus in what application being shown on the display the commands are intended for. In addition, it may interpret input motions on the touch screen 404 into a common format and pass those interpreted motions (e.g., short press, long press, flicks, and straight-line drags) to the appropriate application. The input manager 414 may also report such inputs to an event manager (not shown) that in turn reports them to the appropriate modules or applications. The input manager may pass inputs in the area of a soft keyboard to the IME 415 when IME functionality is activated for a device.

A variety of applications 410 may operate, generally on a common microprocessor, on the device 402. The applications 410 may take a variety of forms, such as mapping applications, e-mail and other messaging applications, web browser applications, music and video players, and various applications running within a web browser or running extensions of a web browser. The applications 410 may include applications that receive input in a character set such as Chinese or Japanese characters, and the IME 415 may serve as a translation layer between input from a user in Roman characters and such applications 410.

A wireless interface 408 manages communication with a wireless network, which may be a data network that also carries voice communications. The wireless interface may operate in a familiar manner, such as according to the examples discussed below, and may provide for communication by the device 402 with messaging services such as text messaging, e-mail, and telephone voice mail messaging. In addition, the wireless interface 408 may support downloads and uploads of content and computer code over a wireless network.

Various forms of persistent storage may be provided, such as using fixed disk drives and/or solid state memory devices. Two examples are shown here. First, dictionary 416 includes relationships between entered characters and other characters that they might represent, where the likelihood that entered characters represent certain other characters is saved in a manner so that suggestions or candidates for a solution to a text entry can be provided in decreasing order of likelihood. The dictionary 416 may be used to help complete incomplete entry, to disambiguate entry that occurs on a keyboard having multiple characters assigned to each key, or to IME applications that convert data entry in a first character set to output in a second character set. The dictionary 416 may include a single monolithic dictionary, or multiple atomic dictionaries as discussed above.

Other storage includes user defaults 418, which may be profile information for a user stored on the same media as the dictionary 416. The user defaults 418 include various parameters about a user of the device 402. In the example relevant here, the user profile may include data defining the manner in which the user prefers to have keyboards displayed on a device, a language that a user prefers to operate in (so as to, in some circumstances, cause an IME interface to be provided to the user automatically when they launch an application that take textual input).

Using the pictured components, and others that are omitted here for clarity, the device 402 may provide particular actions in response to user inputs. Specifically, the device 402 may respond to inputs by a user by suggesting candidates in a different character set. Also, certain inputs may cause changes to occur in keyboards and in candidate boxes or windows.

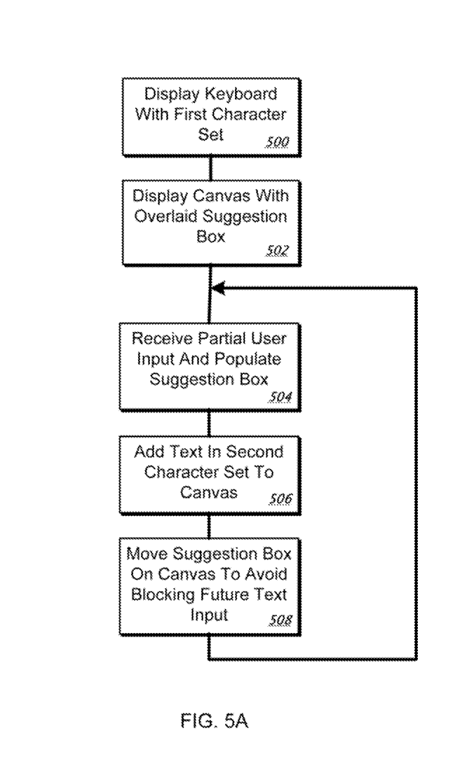

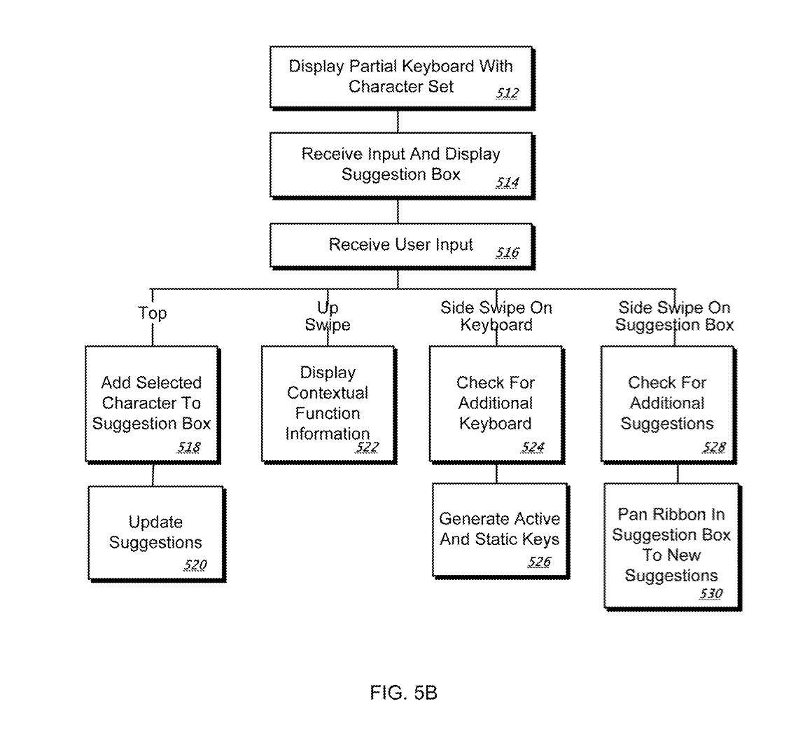

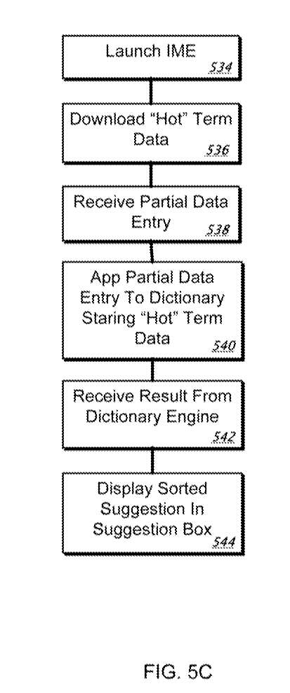

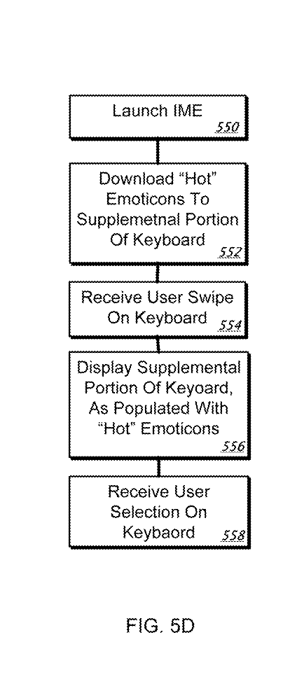

FIG. 5A is a flow chart of an example process for providing an automatically moving candidate box. In general, the process involves displaying a candidate area over a canvas area where text is being entered, and moving the candidate area as text is entered onto the canvas area so as to maintain the candidate area out of the way of the text that is to be entered. In this manner, the canvas area may be larger then if the candidate area were set in a single location, such as by it being docked to the top of a keyboard.

The process begins at box of 402, where a keyboard is displayed showing a first character set. The character set may be, for example, the Roman or Latin character set, and the keyboard may be part of a standard IME implementation. The keyboard may be a soft keyboard, so that a user types on top of a screen to enter information into the keyboard, and so that information on the keyboard may be moved or changed, such as when the device is moved from a portrait mode into a landscape mode.

At box 504, the canvas is displayed with an overlaid suggestion or candidate box. The canvas may take a variety of forms depending on the particular applications that the user is currently entering data into. For example, the application may be a word processing application, a text messaging application, or an e-mail application, and the canvas may represent the page on which a user writes for such applications. Data may be displayed on the canvas as the user enters the data. However, in the context of an IME, a user frequently enters data in the first character set, and the result in a second character set is not displayed until a user selects a particular result from among the proffered candidates. The candidate window may thus be the mechanism for displaying multiple results in response to an entry of information from a user.

At box 506, a partial user input is received and the suggestion or candidate box is populated with candidate solutions for that partial user input. For example, a user may input a limited number of characters that may be mapped to multiple characters or sets of characters in a target character set. At box 508, the user has selected a particular candidate, and text in a second character set for that candidate is added to the canvas. Such addition commonly may include showing symbolic characters, such as those in Chinese, which may be distinguished from letter-based characters like those in the Roman alphabet.

With the new text added to the canvas, a text entry point for the application that generates the canvas may move to a new location, such as by moving down one line on the canvas. In such a situation, where the suggestion or candidate box is located at the bottom of the canvas, the next input may normally occur conceptually beneath the suggestion or candidate box. In such a situation, the canvas may be scrolled upward so that the newly added text may be seen above the suggestion or candidate box. Alternatively, the candidate box may be moved upward, over an area of the canvas in which text has already been entered, such as by moving the candidate box near the top of the canvas.

Also, if a user has generally only employed the leftmost portion of the canvas for entering text, the aspect ratio of the candidate box may change from being relatively long horizontally and short vertically, to being relatively long vertically and relatively narrow horizontally. For example, the candidate box may be moved to the right-hand edge of the screen where it is out of the way of most text that may have been entered by a user. At the end of the process, the process returns to the area above box 506, and waits to receive additional inputs from a user or users.

FIG. 5B is a flow chart of an example process for reacting to user input to an IME system. The process generally shows manners in which an IME application can react to distinct functional inputs from a user.

The process begins at box 512, where a partial keyboard with a first character set is displayed. The keyboard is referenced here as being partial because it includes additional keys that are not initially displayed on the keyboard, but that can be displayed in reaction to a user input to replace certain other keys on the keyboards. At box 514, the device receives input in a normal manner. For example, a user may type Roman characters into a text entry area of an IME, and the IME system may display one or more candidates in a second character set that match the information entered by the user. The user may continuing entering such characters for an indeterminate amount of time.

Eventually, the user may want to stop entering text, and may instead want to affect the look or feel of the IME application or the underlying application that receives the text entry. As a result, the device may receive a user input (box 516) that differs from the normal entry of characters into such a system. In this example, four such distinct user inputs are represented. At box 518, for example, a user enters a tap input onto a keyboard of the IME. Such a tap on the keyboard may be interpreted as an intent to add the underlying Roman character to a solution, and thus, the suggestions or candidates may be updated to reflect the most newly entered data.

At box 522, the system reacts to an up swipe motion by the user. The process may interpret such an input as indicating that the user would like to affect the entry of text in the first character set in a particular manner. For example, such a motion may be interpreted to affect the response of each key on a keyboard, such as by turning each key to a capital letter, or to a function key combination, to an emoticon, or to another form of keyboard. (A down swipe after the initial upswipe may return the keyboard to its initial state.)

Another user input may include a side swipe motion on the keyboard itself. Such an input may result in the soft keyboard sliding in a particular direction, so that portions of a keyboard that are commonly used (but not as commonly as the main, initially displayed keyboard) may be displayed, such as emoticons or other frequently used combinations of one or more key presses. The swiping motion may result, as shown in box 524, in the device determining whether there is any additional keyboard in the direction that the user swiped. If there is, then the device can, on its display, generate a new view of the keyboard.

Such a view may include both static and active keys. A static key is one that typically does not change on a device, such as the letters of the alphabet. An active key is one whose content is intended to change. For example, certain keys may be reserved so that popular characters or phrases can be added easily to a keyboard on a device, and even pushed out to the device from a central server.

The fourth user option includes conducting a lateral swipe on a suggestion or candidate box. Such a swipe first results in the system determining whether additional candidates exist off the edge of the screen (box 528) and then in panning a ribbon that is representative of the candidates, as explained above.

FIG. 5C is a flow chart of an example process for providing hot terms as candidates on a mobile device. In general, the process involves identifying, at a server system, a plurality of terms that are, or are becoming, popular with a variety of users. In this manner, such terms may be suggested to a user under the assumption that the user is likely to be writing about or searching for terms that are popular with other users.

The process begins at box 534, where an IME is initially launched. The IME may include a candidate window, and thus may need to make educated cases about what a user is trying to enter into the system. At box 536, a “hot” list is downloaded, and includes a list of recently popular terms or other items such as emoticons. The hot list may be added to a dictionary for an IME so that the popular terms or phrases are at the top of suggested candidates for a user of the device. For example, the terms in the hot list may be added to a dictionary of terms and may be given (at least temporarily) high rating scores relative to other more static terms in a dictionary. The addition to the dictionary may operate by incorporating the terms into a base dictionary, or by adding a number of atomic dictionaries to a system, and then ranking possible solutions by looking to each such dictionary that has been loaded onto a device.

At box 538, the user provides one or more Roman characters to their device. At box 540, the partial entry is applied to the dictionary or other structure that is to generate solutions for the user in a second character set. As noted, the dictionary or other structure may store data reflecting the relative popularity of such terms being used in a similar manner (e.g., matching use in e-mail when the user is employing the IME to write e-mails). A dictionary engine or other module may, at box 542, return a result of candidates that could match the text that has been entered, and may sort the results by the degree to which they accurately reflect expected behavior of the user. Thus, at box 544, the process displays the matching suggestions or candidates, sorted according to their importance, as judged at least partially by their popularity in a larger server-based system

FIG. 5D is a flow chart of an example process for providing hot emoticons or other symbols on a soft keyboard. In general, the process involves the loading and presentation of hot emoticons in the context of an IME application.

The process begins at box 550, where the IME application is launched. As with the prior process, the IME process may then download from a server system one or more “hot” emoticons. However, instead or in addition to adding such emoticons to a dictionary on a device, the emoticons may be applied directly to keys on the device's auxiliary keyboard portions, as shown in the figures above.

The selection of emoticons for the keyboard may be slowed so as to reduce the “churn” of emoticons on a keyboard, that a user does not learn the keyboard with a particular emoticon and then have that emoticon suddenly disappear from their keyboard as soon as it gets unpopular. Thus, for example, certain delays may be built in so as to slow the emergence and dissipation of emoticons from being provided to client keyboards. Also, the number of times that a user selects a particular emoticon may be tracked, and emoticons that are used more than a threshold number of times may be saved from being removed or replaced, with the understanding that the user employs them often and would not want them to change.

At box 554, the emoticons may be used, as instigated by a user swipe on a keyboard (box 554). For example, the emoticons may be placed on the keys of an auxiliary or supplemental portion of the virtual keyboard, which is not ordinarily visible. Such supplemental portion may be displayed if the user applies a swiping input such as a lateral swipe on the surface of the soft keyboard on a touch screen (box 556). The additional portion of the keyboard, including the emoticons, may then be open for user input, and a user may press keys on the supplemental portion of the keyboard to make such input (box 558).

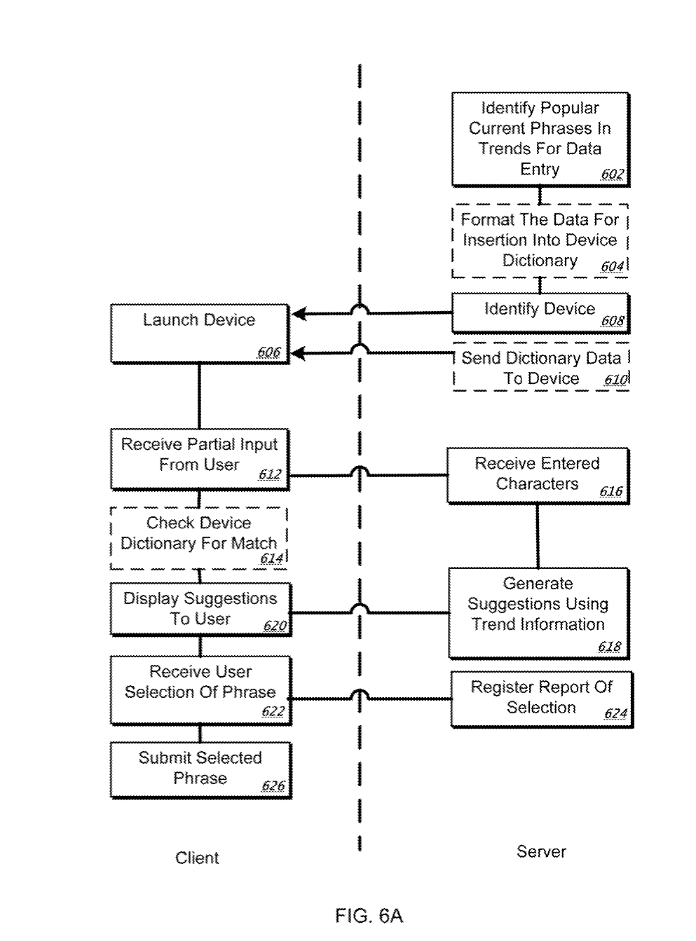

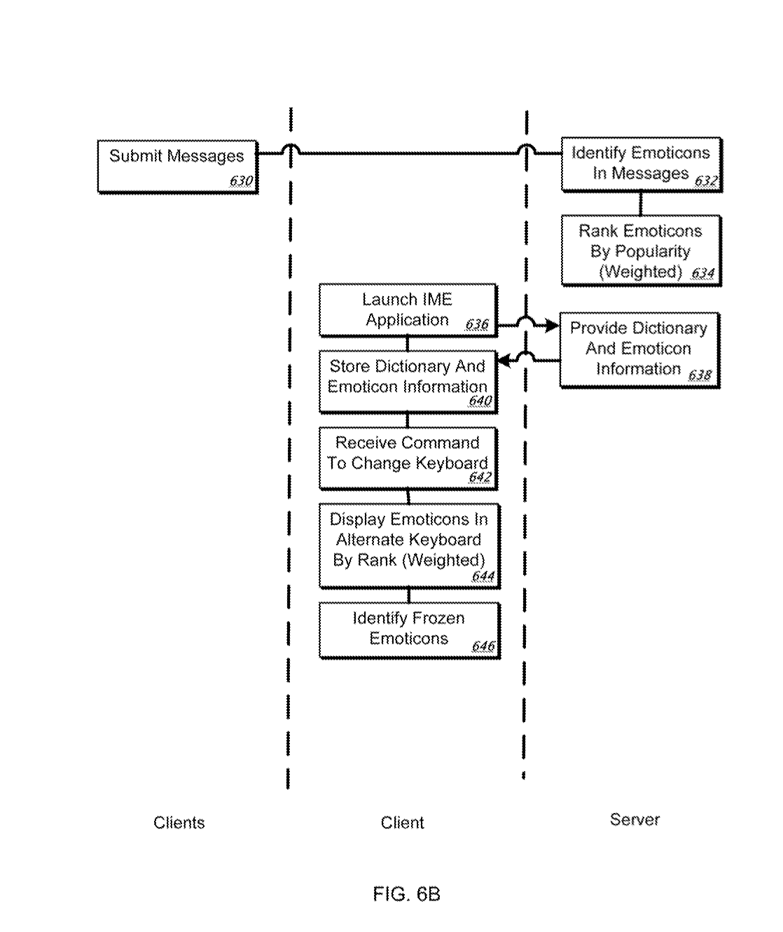

FIG. 6A is a swim lane diagram of an example process for providing current candidates for a user of a mobile device. In general, the process shows example interactions between a client device and a server system whereby a dictionary may be dynamically updated for the device, such that ambiguous entries are resolved into candidates or actual selections using such information.

The process begins at box 602, where a server system identifies current popular terms or phrases. For example, the system may analyze a log of search engine queries to determine common queries that may have been triggered by a particular topic becoming a focus of the popular media. The provision of such data may be performed by the server system as a user enters ambiguous input, or by the user's device. In the latter instance, and as shown by a dashed box 604, the server system formats data concerning such popular terms and phrases for insertion into a dictionary on the user device (604).

At box 606, the device is launched and identifies itself to the server system (box 608), which will send dictionary data to the device when such data is intended to be used by the device itself. At some later time (box 612), a user can provide a partial input to the device so that the input is ambiguous. Where the dictionary data has been transmitted to the device, the device can itself check for matches and score and rank them (box 614). Alternatively, as the user enters characters, the characters can be submitted to the server system (box 616), which may itself identify candidates, including by incorporating the candidates determined in box 602 The server system can also generate suggestions or candidates from such information and provide such suggestions over a network to the device.

At box 620, the client device displays the suggestions or candidates for the user's input to the user, including by using the information on “hot topics.” A user selects one of the candidates at box 622, and the server system can register the user's selection of the particular term. In that manner, the server system may automatically increase the score in a dictionary of the term that the user selects, under the assumption that the word is relatively popular and likely to be used by other users. After the user has selected a candidate or suggestion, it is provided to the relevant application that is controlling the canvas on a device. The process then ends and may repeat for additional entries.

FIG. 6B is a swim lane diagram of an example process for providing popular emoticons to a computing device. In general, the process shows the interaction of a particular client with a server system, as affected by the interaction of other clients with the server system. The process generally involves providing emoticons that may be important or popular to a mobile device so that a user may have simple contact with a keyboard on their device to have the emoticons added to one of their messages on their device.

The process begins at box 630 where various users submit messages, such as e-mail messages or search queries, to the server system, which in turn identifies emoticons or other objects in the messages (box 632). The server system then ranks particular emoticons according to their frequency of occurrence in the target data set. Such a data set may be permanent and may also be dynamic in that it may react to popularity over a shorter period, such as over a holiday or holiday season.

Later, a user launches an IME application (box 636), which causes the application to contact the server system. The server system then responds by sending emoticon information to the client device (box 638) formatted in a manner that it can be easily deployed and used by the client device. At box 640, then, the client device stores the dictionary data received from the server system where it may be used to affect the look of a keyboard such as a supplemental area of a keyboard on a device.

Thus, at box 642, a user provides a command to the client device to change from a standard alphanumeric keyboard to a supplemental keyboard whose keys represent various additional items such as emoticons. At box 644, the supplemental keyboard is displayed, and the most popular emoticons are displayed in an area on the supplemental portion of the keyboard. Certain other emoticons may be more permanent rather than based simply on general public popularity. For example, a user may see an emoticon they like and may enter a command to “freeze” that particular emoticon on their keyboard (e.g., by long pressing on the key and selecting a “freeze” command from a menu that pops up as a result of the long press). Alternatively the device may track the number of times that a particular key is used and may prevent frequently-used keys form being updated. Such keys may be considered to be “frozen”, and can be identified at box 646 so that they are not overwritten when the rest of the keys are overlaid with the popular emoticons (box 644).

In this manner, the keys of a keyboard can be populated, at least in part, using information received from a plurality of different third parties, so that the keys represent information that has been determined to be popular with those third parties.

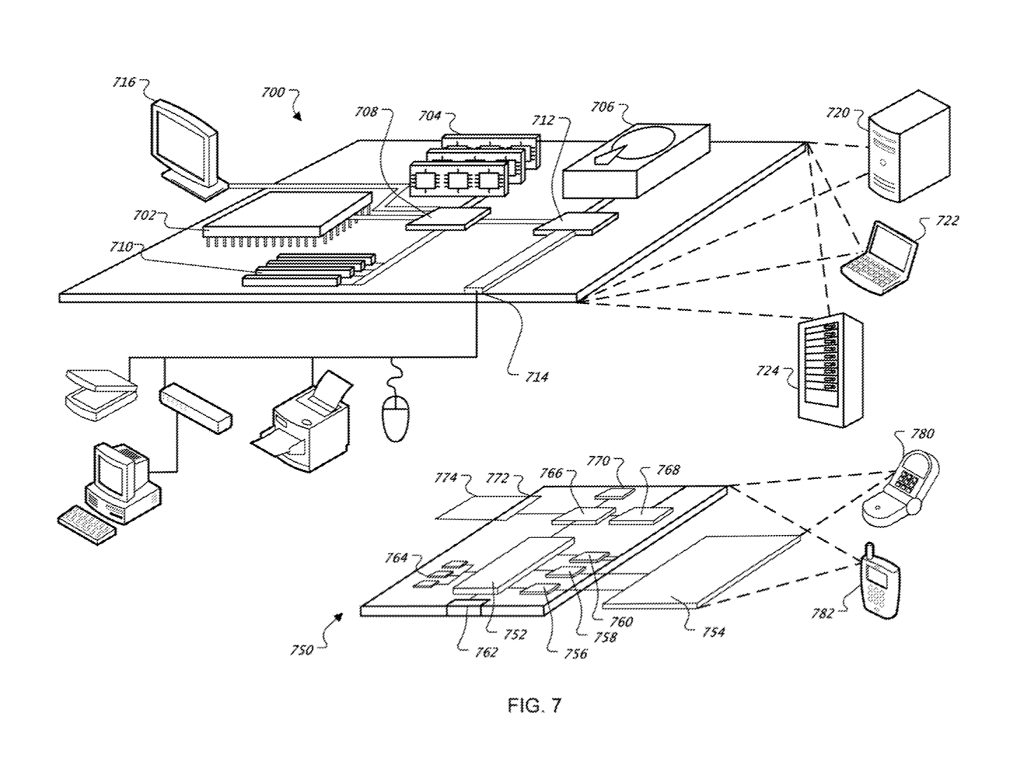

FIG. 7 shows an example of a generic computer device 700 and a generic mobile computer device 750, which may be used with the techniques described here. Computing device 700 is intended to represent various forms of digital computers, such as laptops, desktops, workstations, personal digital assistants, servers, blade servers, mainframes, and other appropriate computers. Computing device 750 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 700 includes a processor 702, memory 704, a storage device 706, a high-speed interface 708 connecting to memory 704 and high-speed expansion ports 710, and a low speed interface 712 connecting to low speed bus 714 and storage device 706. Each of the components 702, 704, 706, 708, 710, and 712, are interconnected using various busses, and may be mounted on a common motherboard or in other manners as appropriate. The processor 702 can process instructions for execution within the computing device 700, including instructions stored in the memory 704 or on the storage device 706 to display graphical information for a GUI on an external input/output device, such as display 716 coupled to high speed interface 708. In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system).

The memory 704 stores information within the computing device 700. In one implementation, the memory 704 is a volatile memory unit or units. In another implementation, the memory 704 is a non-volatile memory unit or units. The memory 704 may also be another form of computer-readable medium, such as a magnetic or optical disk.

The storage device 706 is capable of providing mass storage for the computing device 700. In one implementation, the storage device 706 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 704, the storage device 706, memory on processor 702, or a propagated signal.

The high speed controller 708 manages bandwidth-intensive operations for the computing device 700, while the low speed controller 712 manages lower bandwidth-intensive operations. Such allocation of functions is exemplary only. In one implementation, the high-speed controller 708 is coupled to memory 704, display 716 (e.g., through a graphics processor or accelerator), and to high-speed expansion ports 710, which may accept various expansion cards (not shown). In the implementation, low-speed controller 712 is coupled to storage device 706 and low-speed expansion port 714. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 720, or multiple times in a group of such servers. It may also be implemented as part of a rack server system 724. In addition, it may be implemented in a personal computer such as a laptop computer 722. Alternatively, components from computing device 700 may be combined with other components in a mobile device (not shown), such as device 750. Each of such devices may contain one or more of computing device 700, 750, and an entire system may be made up of multiple computing devices 700, 750 communicating with each other.

Computing device 750 includes a processor 752, memory 764, an input/output device such as a display 754, a communication interface 766, and a transceiver 768, among other components. The device 750 may also be provided with a storage device, such as a microdrive or other device, to provide additional storage. Each of the components 750, 752, 764, 754, 766, and 768, are interconnected using various buses, and several of the components may be mounted on a common motherboard or in other manners as appropriate.

The processor 752 can execute instructions within the computing device 750, including instructions stored in the memory 764. The processor may be implemented as a chipset of chips that include separate and multiple analog and digital processors. The processor may provide, for example, for coordination of the other components of the device 750, such as control of user interfaces, applications run by device 750, and wireless communication by device 750.

Processor 752 may communicate with a user through control interface 758 and display interface 756 coupled to a display 754. The display 754 may be, for example, a TFT LCD (Thin-Film-Transistor Liquid Crystal Display) or an OLED (Organic Light Emitting Diode) display, or other appropriate display technology. The display interface 756 may comprise appropriate circuitry for driving the display 754 to present graphical and other information to a user. The control interface 758 may receive commands from a user and convert them for submission to the processor 752. In addition, an external interface 762 may be provide in communication with processor 752, so as to enable near area communication of device 750 with other devices. External interface 762 may provide, for example, for wired communication in some implementations, or for wireless communication in other implementations, and multiple interfaces may also be used.

The memory 764 stores information within the computing device 750. The memory 764 can be implemented as one or more of a computer-readable medium or media, a volatile memory unit or units, or a non-volatile memory unit or units. Expansion memory 774 may also be provided and connected to device 750 through expansion interface 772, which may include, for example, a SIMM (Single In Line Memory Module) card interface. Such expansion memory 774 may provide extra storage space for device 750, or may also store applications or other information for device 750. Specifically, expansion memory 774 may include instructions to carry out or supplement the processes described above, and may include secure information also. Thus, for example, expansion memory 774 may be provide as a security module for device 750, and may be programmed with instructions that permit secure use of device 750. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 764, expansion memory 774, memory on processor 752, or a propagated signal that may be received, for example, over transceiver 768 or external interface 762.

Device 750 may communicate wirelessly through communication interface 766, which may include digital signal processing circuitry where necessary. Communication interface 766 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 768. In addition, short-range communication may occur, such as using a Bluetooth, WiFi, or other such transceiver (not shown). In addition, GPS (Global Positioning System) receiver module 770 may provide additional navigation- and location-related wireless data to device 750, which may be used as appropriate by applications running on device 750.

Device 750 may also communicate audibly using audio codec 760, which may receive spoken information from a user and convert it to usable digital information. Audio codec 760 may likewise generate audible sound for a user, such as through a speaker, e.g., in a handset of device 750. Such sound may include sound from voice telephone calls, may include recorded sound (e.g., voice messages, music files, etc.) and may also include sound generated by applications operating on device 750.

The computing device 750 may be implemented in a number of different forms, as shown in the figure. For example, it may be implemented as a cellular telephone 780. It may also be implemented as part of a smart phone 782, personal digital assistant, or other similar mobile device.

Device 750 may also include one or more different devices that are capable of sensing motion. Examples include, but are not limited to, accelerometers and compasses. Accelerometers and compasses, or other devices that are capable of detecting motion or position are available from any number of vendors and can sense motion in a variety of ways. For example, accelerometers can detect changes in acceleration while compasses can detect changes in orientation respective to the magnetic North or South Pole. These changes in motion can be detected by the device 750 and used to update the display of the respective devices 750 according to processes and techniques described herein.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the invention. For example, much of this document has been described with respect to messaging and mapping applications, but other forms of graphical applications may also be addressed, such as interactive program guides, web page navigation and zooming, and other such applications.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

1. A computer-implemented user interface method, comprising:
displaying on a touch screen of a computing device a keyboard defined by a first character set;
displaying on the touch screen an electronic canvas on which information corresponding to keys on the keyboard is displayed as a user selects the keys on the keyboard, the information appearing in a second character set that differs from the first character set;
generating a candidate area over a front surface of the canvas; and
automatically controlling a location of the candidate area as information is added to the canvas so as to move the candidate area away from being over a location on the canvas that is presently, or next to be, a location at which information is added to the canvas.

2. The method of claim 1, further comprising receiving a user input to dock the candidate area to the keyboard, and subsequently maintaining the candidate area docked to the keyboard until a subsequent user input to undock the candidate area from the keyboard.

3. The method of claim 2, wherein the first character set comprises a Roman-based character set and the second character set comprises a symbolic character set.

4. The method of claim 1, further comprising receiving a user selection of a candidate in the candidate area, adding the selected candidate to the canvas, and moving the candidate area if the candidate area substantially obscures a next data entry area on the canvas.

5. The method of claim 1, further comprising changing an aspect ratio of the candidate area and moving the candidate area laterally near a side of the display.

6. The method of claim 1, further comprising receiving a lateral swiping input on the keyboard, and panning the keyboard in a direction of the lateral swiping input.

7. The method of claim 1, further comprising receiving a lateral swiping motion in the candidate area, and panning a plurality of candidate entries in the candidate area in response to the lateral swiping motion.

8. An article comprising a computer-readable data storage medium storing program code operable to cause one or more machines to perform operations, the operations comprising:
displaying on a touch screen of a computing device a keyboard defined by a first character set;
displaying on the touch screen an electronic canvas on which information corresponding to keys on the keyboard is displayed as a user selects the keys on the keyboard, the information appearing in a second character set that differs from the first character set;
generating a candidate area over a front surface of the canvas; and
automatically controlling a location of the candidate area as information is added to the canvas so as to move the candidate area away from being over a location on the canvas that is presently or about to be a location at which information is added to the canvas.

9. The article of claim 8, wherein the program code is operable to perform operations including receiving a user input to dock the candidate area to the keyboard, and subsequently maintaining the candidate area docked to the keyboard until a subsequent user input to undock the candidate area from the keyboard.

10. The article of claim 8, wherein the first character set comprises a Roman-based character set and the second character set comprises a symbolic character set.

11. The article of claim 8, wherein the program code is operable to perform operations including receiving a user selection of a candidate in the candidate area, adding the selected candidate to the canvas, and moving the candidate area if the candidate area substantially obscures a next data entry area on the canvas.

12. The article of claim 8, wherein the program code is operable to perform operations including changing an aspect ratio of the candidate area and moving the candidate area laterally near a side of the display.

13. The article of claim 8, wherein the program code is operable to perform operations including receiving a lateral swiping input on the keyboard, and panning the keyboard in a direction of the lateral swiping input.

14. The article of claim 8, wherein the program code is operable to perform operations including receiving a lateral swiping motion in the candidate area, and panning a plurality of candidate entries in the candidate area in response to the lateral swiping motion.

15. A computer-implemented user interface system, comprising:
a graphical display system to present an input method editor and a text entry application having a canvas area for displaying user-entered information and a candidate area for presenting symbols to be added to the canvas area;
a touch screen user input mechanism to receive user selections in coordination with the display of the input method editor; and
an input method interface manager module that is operable with the input method editor to automatically control a location of the candidate area as information is added to the canvas so as to move the candidate area away from being over a location on the canvas that is presently, or next to be, a location at which information is added to the canvas.

16. The system of claim 15, image method editor is operable to receive input in a first character set and generate output in a second character set that is different than the first character set that does not correspond to keys on the touch screen user input mechanism.

17. The system of claim 15, wherein the input method interface manager module is further operable to receive a user selection of a candidate in the candidate area, provide the selected candidate for addition to the canvas, and cause the candidate area to be moved if the candidate area substantially obscures a next data entry area on the canvas.

18. The system of claim 15, wherein the input method interface manager module is further operable to automatically change an aspect ratio of the candidate area and move the candidate area laterally near a side of the display.

19. The system of claim 15, wherein the touch screen user input mechanism is operable to receive a lateral swiping input on a keyboard displayed on the graphical display, and the graphical display system is operable to pan the keyboard in a direction of the lateral swiping input, in response to the lateral swiping input.

20. The system of claim 15, wherein the touch screen user input mechanism is operable to receive a lateral swiping input on the candidate area, and the graphical display system is operable to pan a plurality of candidate entries in the candidate area in response to the lateral swiping motion.

21. A computer-implemented user interface system, comprising:
a graphical display to present an input method editor and a text entry application having a canvas area for displaying user-entered information;
a touch screen user input mechanism to receive user selections in coordination with the display of the input method editor; and
means for generating a floating candidate window over a portion of the canvas.
